(19) United States
(12) Patent Application Publication
(10) Pub. No.: US 2024/0189168 A1
(43) Pub. Date: Jun. 13, 2024

(54) System And Method For Positioning A Patient

(71) Applicant: The Morel Company LLC, Batesville, IN (US)

(72) Inventors: William A. Hillenbrand, Batesville, IN (US); Joseph Kummer, Cincinnati, OH (US); David Hornbach, Brookville, IN (US); Glenn Suttman, Batesville, IN (US)

(73) Assignee: The Morel Company LLC, Batesville, IN (US)

(21) Appl. No.: 18/286,694

(22) PCT Filed: Apr. 14, 2022
(86) PCT No.: PCT/US22/24835

§ 371 Date: Oct. 12, 2023

Related U.S. Application Data
(60) Provisional application No. 63/175,389, filed on Apr. 15, 2021.

(51) Int. Cl. A61G 7/10

(52) U.S. Cl. CPC A61G 7/1015; A61G 7/1042; A61G 7/1061

(57) ABSTRACT

A system and method of positioning a patient residing on a sheet located on a mattress includes moving to a first position opposing engagement members of a clamp, inserting a first side edge of the sheet between the opposing engagement members, moving the opposing engagement members to a second position so as to grasp the first side edge of the sheet, and causing a pulling device to pull the clamp and thus the sheet upwards so as to at least partially reposition the patient from an initial position towards a second side of the mattress. The sheet has opposing longitudinal side edges that may be retained by retainers located along corresponding opposing longitudinal first and second sides of the mattress.

### CROSS REFERENCE TO RELATED APPLICATION

This application claims the benefit of priority to U.S. Provisional Patent Application Ser. No. 63/175,389, filed Apr. 15, 2021 (pending), the disclosure of which is incorporated by reference herein in its entirety.

### TECHNICAL FIELD

The invention relates generally to an efficient and user-friendly system and method of positioning a patient lying on a sheet on a mattress.

### BACKGROUND

While a patient is staying at a hospital, medical facility, or being cared for at home, they may lie for extended periods in their bed. Moreover, that patient may be unable to voluntarily change positions, such as rolling from their back or to their side. When that patient spends too much time in one position, such as on their back, the skin may breakdown because of pressure and lack of blood circulation. This condition is commonly referred to as a bedsore. As blood flow is restricted, the skin starts to die and the bedsore starts as a red, painful area, which eventually turns to purple and then to black. Left untreated, the skin may break open and become infected. The bedsore may develop in as short as 2-3 hours after the skin is cut off from the blood supply.

To prevent bedsores a doctor may order that the nursing staff turn, offload pressure, or reposition the patient at least every two hours. To turn, offload pressure, or reposition the patient, one or more nurses may have to manually adjust the patient. This process may be difficult if only one nurse is present, especially if the patient is obese. If a bedsore has already developed, the doctor may order that the patient be turned, pressure offloaded, or repositioned so that the bedsore may be treated. Again, the methods of repositioning the patient may require one or more nurses to manually manipulate the patient.

There are other circumstances where a patient may need to be turned or repositioned. For example, a doctor may order a patient be turned or repositioned to prevent hospital-acquired pneumonia or to treat pneumonia. In addition, a patient may need to be turned to have their backside inspected for skin breakdown, inspected for suspect areas, or bathed.

There are multiple circumstances that call for a patient lying in a bed to be turned or repositioned. Having to perform this task may require more than one nurse and it may still be strenuous to turn and reposition the patient, especially if the patient is obese.

### SUMMARY OF THE INVENTION

To these and other ends, the present application discloses, for a patient lying on a sheet that resides on a mattress, a system and method for turning or positioning a patient that may be accomplished with only one nurse and which reduces the physical exertion by the nurse. The sheet has opposing longitudinal side edges that are retained by retainers located along corresponding opposing first and second longitudinal sides of the mattress. The method includes removing a first longitudinal side edge of the sheet from the respective retainers located along the first longitudinal side of the mattress; securing the removed first longitudinal side edge of the sheet to a clamp, the clamp operatively connected to a pulling device located above the mattress; and operating the pulling device to pull upwardly the clamp and the first longitudinal side edge of the sheet that is secured thereto. The upward movement of the first longitudinal side edge of the sheet causes the patient lying thereon to be positioned toward the second longitudinal side of the mattress that is opposite the first longitudinal side. The sheet has a tensile strength which may be greater than a sheet that contains cotton. The securing step further comprises compressing opposite sides of the sheet within a pair of engagement members located within the clamp, so as to not adversely affect the structural integrity of the sheet. The pulling device may be mounted to a ceiling above the mattress or mounted to a mobile frame. In one aspect of the invention, the mattress as a first length and the sheet as a second length that is at least 50% longer that the first length. In another aspect, one side edge of the sheet includes a corded hem and the clamp is configured to grasp the sheet at the corded hem.

In a preferred embodiment, the clamp includes first and second handles pivotally coupled to each other and configured to move between a first position and a second position, wherein the first and second handles are biased to the first position and in the first position the pair of engagement members compress opposite sides of the sheet. When the first and second handles are in the second position the pair of engagement members do not compress opposite sides of the sheet. The clamp may include a spring to bias the first and second handles to the first position. The clamp may include a strap configured to operatively connect the clamp to the pulling device.

The method may further include unsecuring the first longitudinal side edge of the sheet from the clamp and then placing the unsecured first longitudinal side edge back within the retainers on the first longitudinal side of the mattress.

One embodiment of the invention relates to a method of positioning a patient located on a mattress having a first side and a second side, wherein a sheet resides between the patient and the mattress, the sheet having a first side edge proximate the first side of the mattress and a second side edge proximate the second side of the mattress, and a clamp is connected to a pulling device positioned above the mattress.

The method includes moving to an open position opposing engagement members of a clamp configured to pivot between the open position and a closed position. In the closed position the opposing engagement members are configured to grasp onto an object therebetween. The method also includes inserting the first side edge of the sheet between the opposing engagement members, moving the opposing engagement members to the closed position so as to grasp the first side edge of the sheet, and lowering the mattress such that the sheet moves upwards relative to and away from the mattress so as to at least partially reposition the patient from an initial position towards the second side of the mattress.

Another embodiment of the present invention contemplates a method for moving a body part or limb of a patient, instead of the entire patient. To that end, the method includes placing at least part of a lifting structure between the body part of the patient and a support surface, grasping the lifting structure with a clamp connected to a pulling device, and causing the pulling device to pull the clamp and thus the lifting structure upwards so as to at least partially lift the body part away from the support surface. In one aspect, the lifting structure is one of a sling or a strap.

In addition to a method of positioning a patient, the invention also contemplates a system for positioning a patient lying on a mattress supported on a bed. The system includes a sheet residing on the mattress under the patient, the sheet having opposing longitudinal side edges that are retained by retainers located along corresponding opposing longitudinal first and second sides of the mattress, a pulling device located above the mattress, and a clamp operatively connected to the pulling device and adapted to compressively engage opposite sides of a first longitudinal side edge of the sheet after the first longitudinal side edge has been removed from the respective retainers, to thereby secure the sheet to the clamp and enable the pulling device to be operated so as to pull in an upward direction the clamp and the sheet secured thereto. The upward movement of the secured sheet causes the patient to be repositioned toward a second longitudinal side of the mattress opposite the first longitudinal side. In one aspect of the invention, the bed or the pulling device is movable relative to the other. In one aspect, the system may include a housing located at a head end of the bed and operatively connected to a head end of the sheet and adapted to pull the sheet longitudinally along the mattress while the longitudinal side edges thereof are retained by the retainers of the longitudinal sides of the mattress, the sheet having a length that is greater than the length of the mattress.

Other methods and systems for positioning or repositioning a patient are contemplated and are described and claimed below.

The invention also contemplates a clamp for attaching to and lifting an object, such a sheet residing under a patient. In one embodiment, the clamp includes a first side plate having an upper portion, a middle portion, and a lower portion, the middle portion having a slot, first and second link assemblies, each link assembly having first and second ends, the first ends being pivotably couple to the upper portion of the first plate, a lateral member extending at least partially into the slot in the first side plate, a strap bracket operatively coupled to the lateral member, first and second engagement members pivotably coupled to the lower portion of the first side plate, the first and second engagement members being movable between a first position and a second position, and first and second handles, each handle being pivotably coupled to the lateral member, each handle having an upper portion and a lower portion, the upper portion of each handle being pivotably coupled to the second end of respective first and second link assemblies, the lower portion of each handle being coupled to respective first and second engagement members. The lateral member is biased so as to place each engagement member in the first position such that the first and second engagement members may grip an object placed therebetween. When the first and second engagement members are moved to the second position, the gripped object is released from the first and second engagement members. In one aspect, the first and second engagement members are configured such that in the closed position gripping the object the clamping device is lifted by the strap bracket, the first and second engagement members exert a greater gripping force on the object.

### BRIEF DESCRIPTION OF THE DRAWINGS

The accompanying drawings illustrate one or more embodiments of the invention. Together with a general description of the invention given above, and the detailed description given below, may serve to explain the invention.

FIG. 1 is an elevation view of a system for repositioning a patient according to a preferred embodiment of the invention.

FIG. 2 is a perspective view of the clamp depicted in the system of FIG. 1.

FIG. 3 is a partially disassembled perspective view of the clamp of FIG. 2.

FIG. 4 is a partially disassembled perspective view of the clamp of FIG. 2.

FIG. 5A is a partial cross-sectional side view of the clamp of FIG. 2 in an open position to receive the edge of a sheet.

FIG. 5B is a partial cross-sectional side view of the clamp of FIG. 2 in a closed position to retain the edge of a sheet.

FIG. 6 is a partial cross-sectional elevational view of the clamp of FIG. 2.

FIG. 7A is a schematic representation of the clamp of FIG. 2 retaining the edge of a sheet on which a patient is residing.

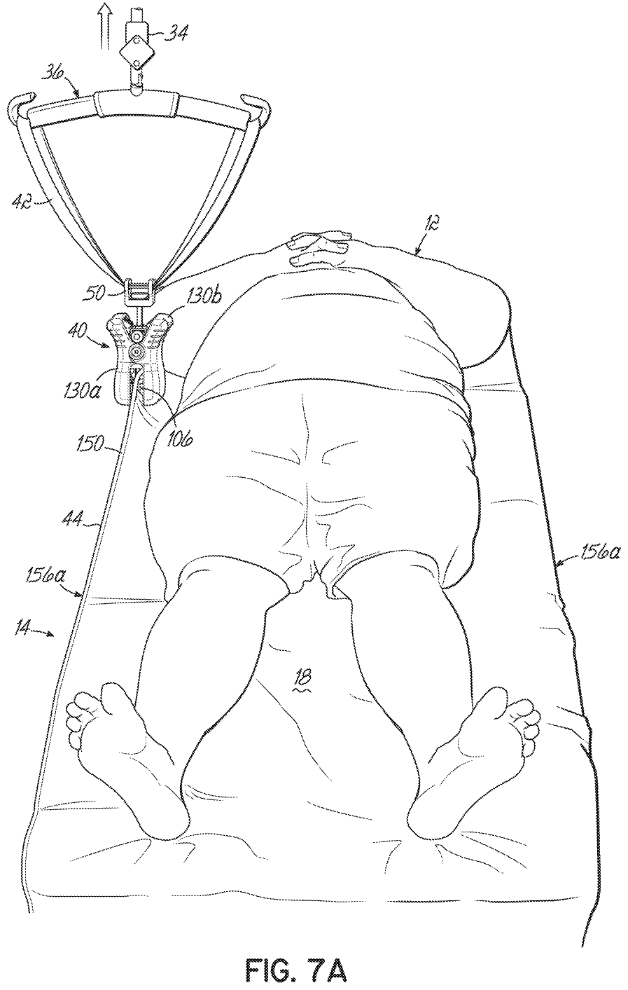

FIG. 7B is a schematic representation of the clamp of FIG. 2 pulling an edge of the sheet and thereby repositioning the patient.

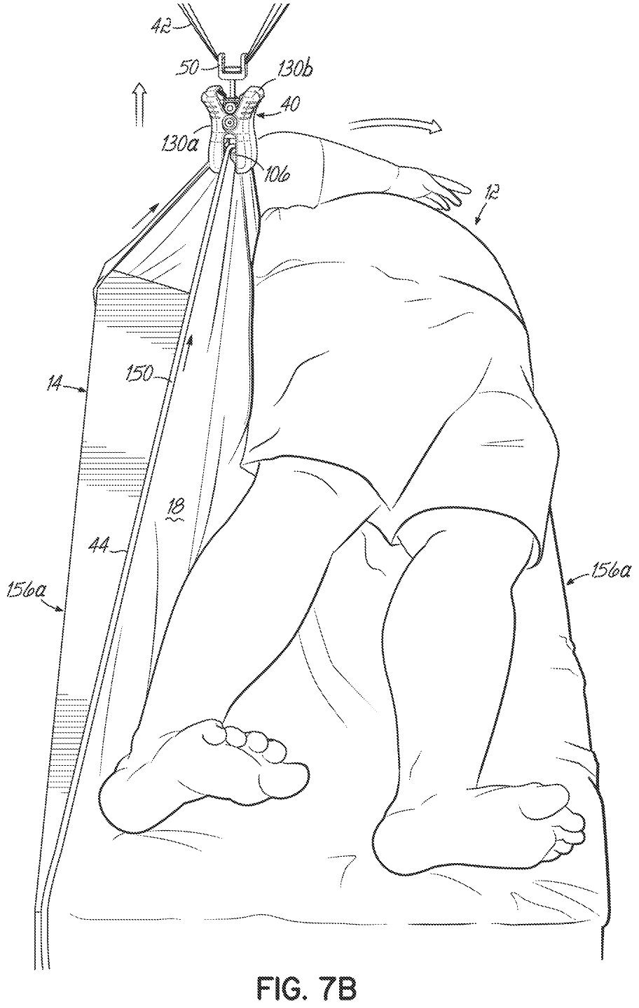

FIG. 8 is an elevational view of the system of FIG. 1 lifting a leg of the patient according to another embodiment of the invention.

### DETAILED DESCRIPTION OF THE INVENTION

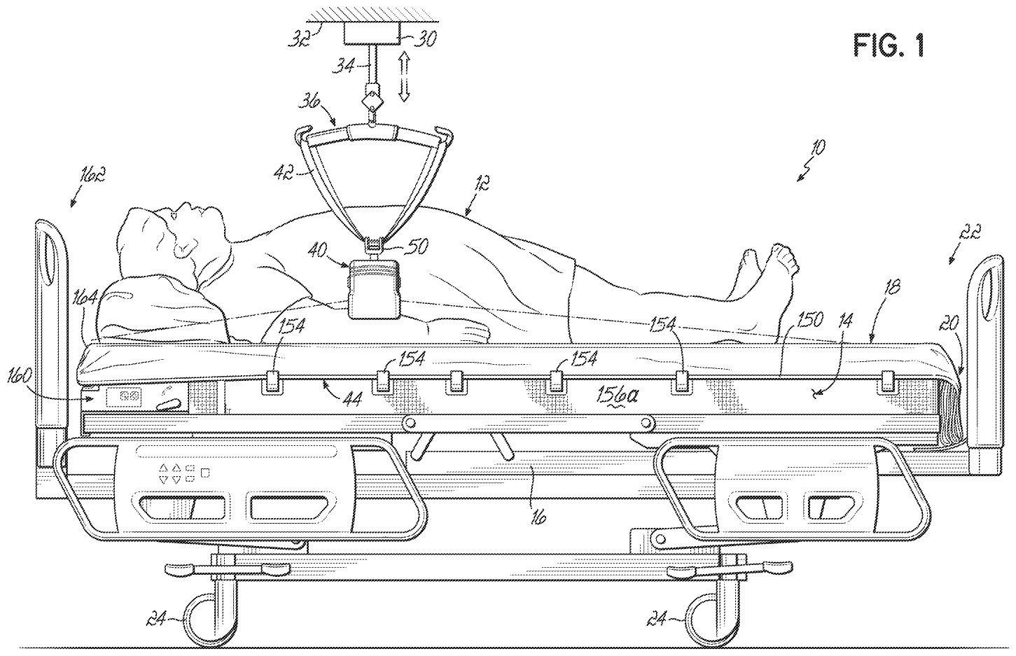

FIG. 1 depicts a system 10 for repositioning a patient 12 lying on a mattress 14 supported by a bed 16 according to one embodiment of the invention. A sheet 18 resides on the mattress 14 under the patient 12. The sheet 18 is a least 50% longer than the length of the mattress 14. In an embodiment, the sheet has a tensile strength greater than a sheet that contains cotton. In an embodiment, the sheet may have a tensile strength of at least 120 pounds. The sheet may be comprised of a synthetic fabric. An extra length 20 of the sheet 18 is positioned at a foot 22 of the bed 16. The bed is supported by wheels 24.

The system 10 further includes a pulling device 30, such as an electric winch for example, mounted to the ceiling 32. Alternatively, the pulling device 30 may be mounted to a mobile frame so that the pulling device 30 may be repositioned relative to the patient 12. A retractable pulling strap 34 is operatively connected to the pulling device 30. In operation the pulling device 30 may release the pulling strap 34 such that it moves downwardly toward the patient 12 or the pulling device 30 may retract the pulling strap 34 such that it moves upwardly away from the patient 12. A yoke 36 is attached to the end of the pulling strap 34. The system 10 further includes a clamp 40 coupled to the yoke via a removeable attachment strap 42. As will be discussed below, the clamp 40 is configured to grasp onto a side edge 44 of the sheet 18 and pull the sheet 18 upwards when the pulling device 30 retracts the pulling strap 34. By pulling upwards on the side edge 44 of the sheet 18, the patient 12 may be repositioned toward the opposite side of the mattress 14. In an embodiment, the system 10 may include a plurality of clamps 40 that may be connected at various positions to the side edge 44 of the sheet 18.

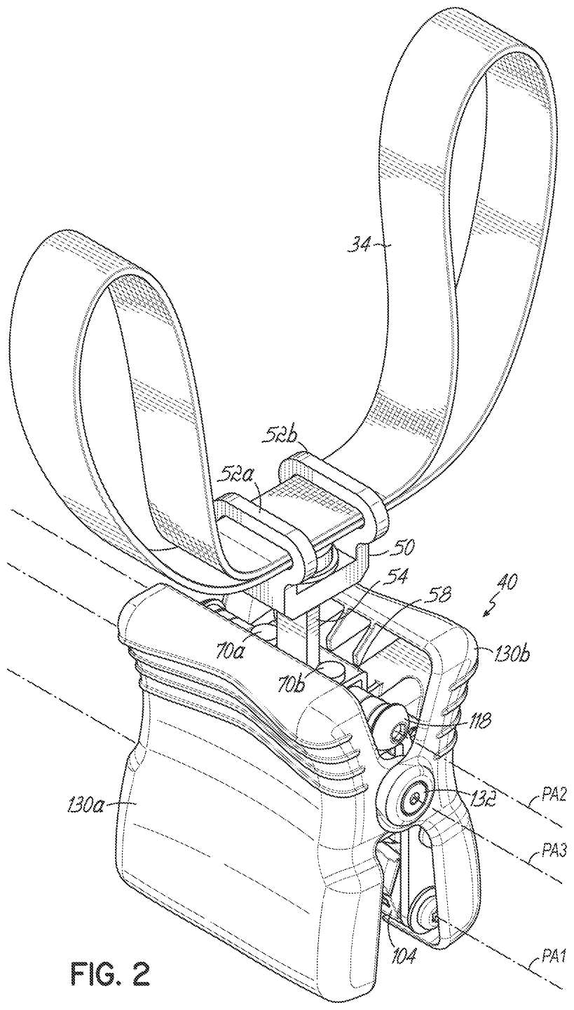

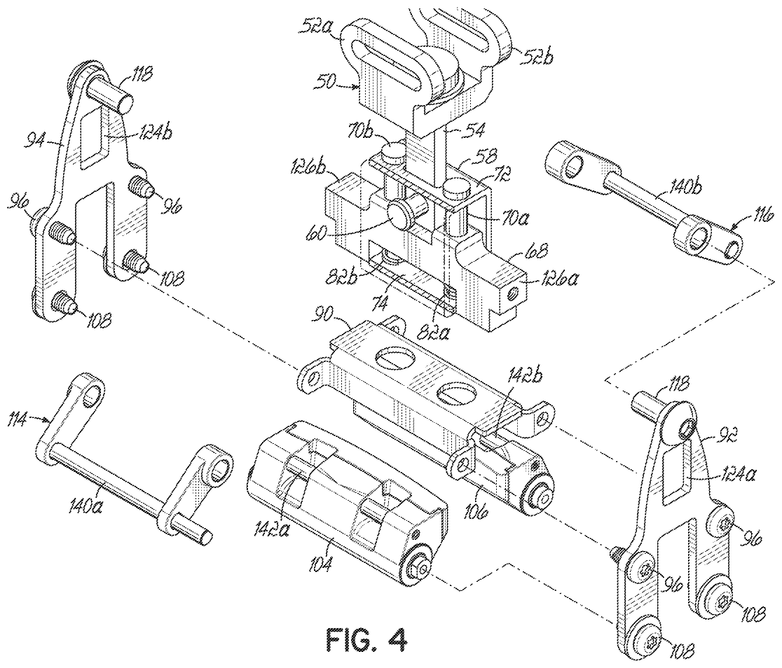

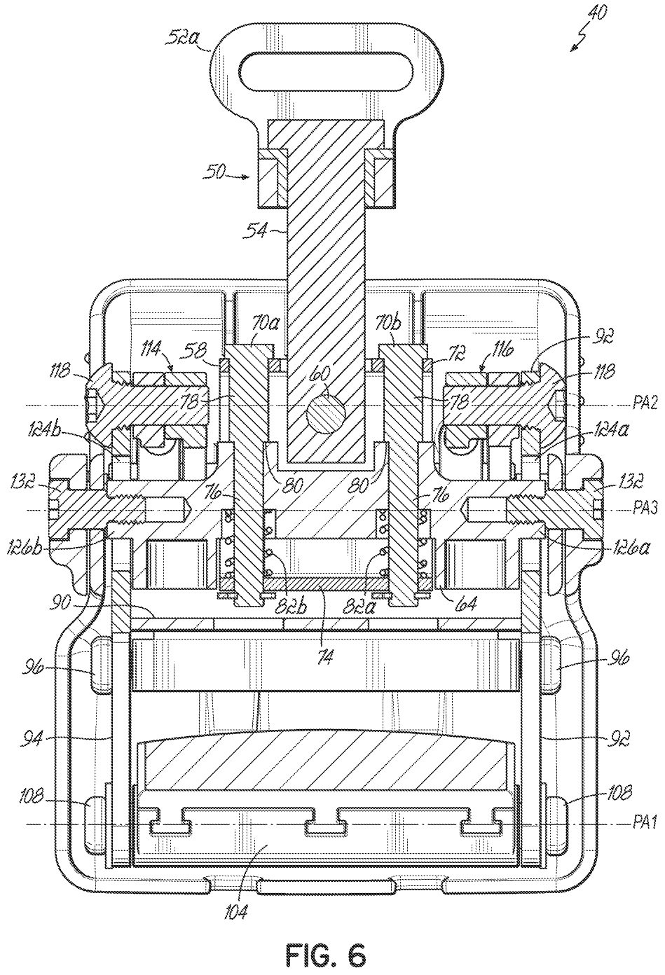

One embodiment of the clamp 40 is depicted in FIGS. 2-6. With reference to FIG. 2, the attachment strap 42 is connected to the clamp 40 via a strap bracket 50 having two strap rings 52a, 52b. The strap bracket 50 is connected to a pulling member 54 which passes through a slot 56 at the top of a housing 58 and is rigidly connected to the housing 58 via a pin 60. In other words, the pulling member 54 does not move relative to the housing 58. With reference to FIG. 4, a lateral member 64 extends through opposing sides of the housing 58 and is slidingly mounted along pins 70a, 70b, which are affixed to a top member 66 and a bottom member 68 of the housing 58. The pins 70a, 70b have a narrow section 76 and a wide section 78 with a shoulder 80 between them. The shoulder 80 limits upward travel of the lateral member 64 along the narrow section 76 of the pins 70a, 70b. A pair of springs 82a, 82b are positioned about the narrow section 76 of each pin 70a, 70b and engage the lateral member 64 so as to bias the lateral member 64 against the shoulder 80 of the pins 70a, 70b.

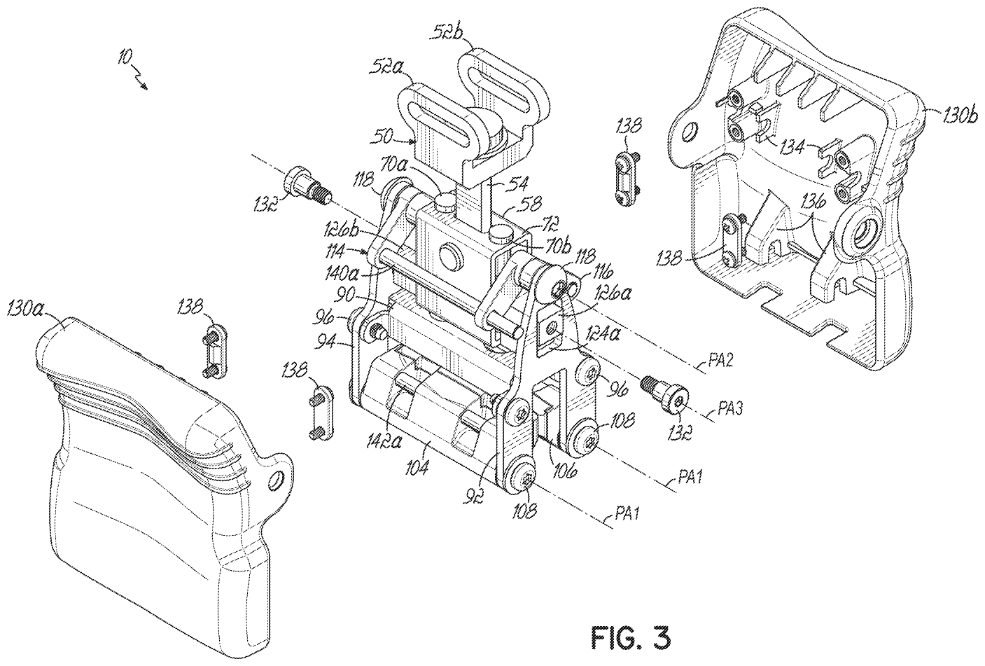

The clamp 40 further includes a cross brace 90 connected to a first side plate 92 and a second side plate 94 via fasteners 96. The first and second side plates 92, 94 have an upper portion, a middle portion, and a lower portion. The lower portion of the first and second slide plates 92, 94 are pivotably coupled to a first engagement member 104 and second engagement member 106 via fasteners 108 so that the first and second engagement members 104, 106 may pivot about pivot axes PA1 (FIG. 3). The upper portion of the first and second slide plates 92, 94 is pivotably coupled to a first link assembly 114 and a second link assembly 116 via pins 118 so the first and second link assemblies 114, 116 may pivot about pivot axis PA2. The middle portion of the first and second slide plates 92, 94 includes elongated openings 124a, 124b configured to allow first and second extensions 126a, 126b of the lateral member 64 to extend into the respective elongated openings 124a, 124b.

The clamp 40 further includes first and second handles 130a, 130b, which are pivotably coupled to the lateral member 64 via fasteners 132. The first and second handles 130a, 130b pivot about pivot axis PA3. Each of the first and second handles 130a, 130b has an upper retaining assembly 134 and a lower retaining assembly 136. The upper retaining assembly 134 includes retaining plates 138 that are configured to retain link pins 140a, 140b, which are part of the first and second link assemblies 114, 116. The lower retaining assembly 136 retains pivot pins 142a, 142b in respective first and second engagement members 104, 106.

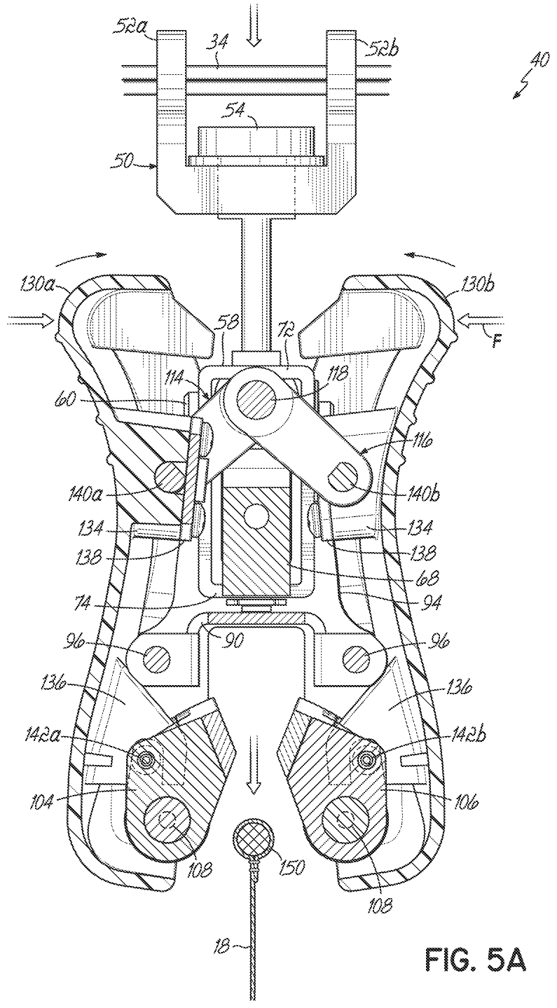

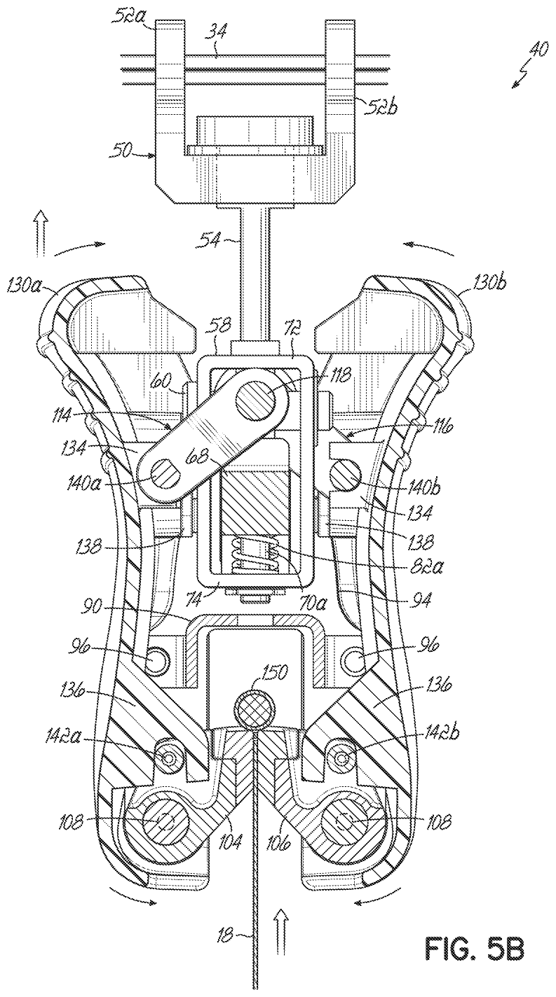

The handles 130a, 130b may pivot between a first position and a second position. In the first position, the engagement members 104, 106 contact one another and, if the sheet 18 is present, compresses opposite sides of the sheet 18 (FIG. 5B). This first position may be considered a closed position for the engagement members, which is the normal position when no external force is applied to the handles 130a, 130b. To get the handles 130a, 130b in the second position, an external force must be applied to the upper portion of the handles 130a, 130b so that the respective upper portions move toward each other. Such motion of the upper portions of the handles 130a, 130b cause the lower portions of the handles 130a, 130b to move away from each other, such that the first and second engagement members 104, 106 no longer contact one another (FIG. 5A) and, if the sheet 18 is present, the first and second engagement members 104, 106 do not compress the opposite sides of the sheet 18. This second position may be considered an open position for the engagement members 104, 106. The springs 82a, 82b serve to bias the handles 130a, 130b to the first or closed position.

The sheet 18 may include a corded hem 150 that extends along the opposing side edges 44 of the sheet 18. The corded hem 150 may be retained by a set of retainers 154 located on opposing first and second longitudinal sides 156a, 156b of the mattress 14. A sheet with a corded hem and exemplary sheet retainers along the sides of a mattress are disclosed in U.S. Pat. No. 9,205,012, the entirety of which is incorporated herein by reference. The side edges 44 of the sheet 18 may be released from each retainer 154 individually so that all or part of the side edges 44 are separated from the mattress 14. In an embodiment, a housing 160 located at a head end 162 of the bed 16 and operatively connected to a head end 164 of the sheet 18 and adapted to pull the sheet 18 longitudinally along the mattress 14 while the opposing side edges 44 of the sheet 18 are retained by the retainers 154 on the first and second longitudinal sides 156a, 156b of the mattress 14.

FIG. 5A depicts an external force F (such as applied by a hand gripping the handles 130a, 130b) being applied to the upper portion of each handle 130a, 130b causing the handles 130a, 130b to pivot able pivot axis PA3 which moves the engagement members 104, 106 away from each other into the open position. The open position of the engagement members 104, 106 allows the corded hem 150 of the sheet 18 to pass between the engagement members as depicting in FIG. 5A. In FIG. 5B, the external force has been removed and the engagement members 104, 106 have moved to the closed position to compress the side edge 44 of the sheet 18. The corded hem 150 is positioned above the engagement members 104, 106, which helps to retain the side edge 44 of the sheet 18 in the engagement members 104, 106. As the clamp 40 moves upward, the sheet 18 is pulled upward as well. The downward tension in the sheet 18 tends to rotate the engagement members 104, 106 about pivot axes PA1 so as to create even greater clamping force on the side edge 44 of the sheet 18. To release the sheet 18 from the engagement members 104, 106, the external force is reapplied to the handles 130a, 130b so that the engagement members 104, 106 move to the open position.

As mentioned above, the clamp 40 may be used in a method of positioning or repositioning a patient 12 lying on the sheet 18. In one embodiment of the method, the opposing side edges 44 of the sheet 18 are retained by the retainers 154 located along the opposing longitudinal sides 156a, 156b of the mattress 14 as depicted in FIG. 1. First, the first side edge 44 of the sheet 18 is removed from the retainers 154 located along the first longitudinal side 156a of the mattress 14. Then, first and second engagement members 104, 106 of the clamp 40 are moved to the second or open position, the first side edge 44 of the sheet 18 is inserted between the first and second engagement members 104, 106, and the first and second engagement members 104, 106 are moved to the second or closed position so as to grasp or compress the first side edge 44 of the sheet 18. With the first side edge 44 grasped, the pulling device is operated to pull upwardly the clamp 40 and the first side edge 44 of the sheet 18 secured to the clamp 40. The upward movement of the first side edge 44 of the sheet 18 causes the patient 12 to be positioned toward the second longitudinal side 156b of the mattress 14, which is opposite the first longitudinal side 156a. In an embodiment, the first side edge 44 of the sheet 18 is compressed with the first and second engagement members 104, 106 during securing so as to not adversely affect the structural integrity of the sheet 18. After the repositioning is completed, the pulling device 30 may be operated to lower the clamp 40 and thus the sheet 18. The first and second engagement members 104, 106 are moved to the second or open position and the first side edge 44 of the sheet 18 is released from the clamp 40 and then the first edge 44 may be placed within or connected to the retainers on the first longitudinal side 156a of the mattress 14.

After the patient 12 is repositioned using the clamp 40 and the pulling device 30, the patient 12 is held in a turned position by caregivers while the sheet 18 is lowered to provide access to the patient's backside. In addition, the patient 12 may also help to keep themselves in the turned position by grasping a siderail that they are turned toward. With the patient 12 turned and the sheet 18 lowered, the caregivers may then inspect or bath the patient 12. Alternatively, the caregivers may place pillows or wedges behind the patient 12 to hold the patient in the turned position and then manually turn the patient 12 back to their original flat position while the pillows or wedges act to keep them in the turned position. This allows the sheet 18 to be returned to its original position while the patient 12 remains in a turned position without the use of the clamp 40 and pulling device 30. Alternatively, the wedges may be placed underneath the sheet 18 before the clamp 40 and sheet 18 is lowered.

In another embodiment of positioning the patient, the clamp 40 is attached to the first side edge 44 of the sheet 18. The mattress 14 is then lowered such that the sheet 18 moves upward relative to and away from the mattress 14 so as to at least partially reposition the patient 12 from an initial position towards the second longitudinal side 156b of the mattress 14.

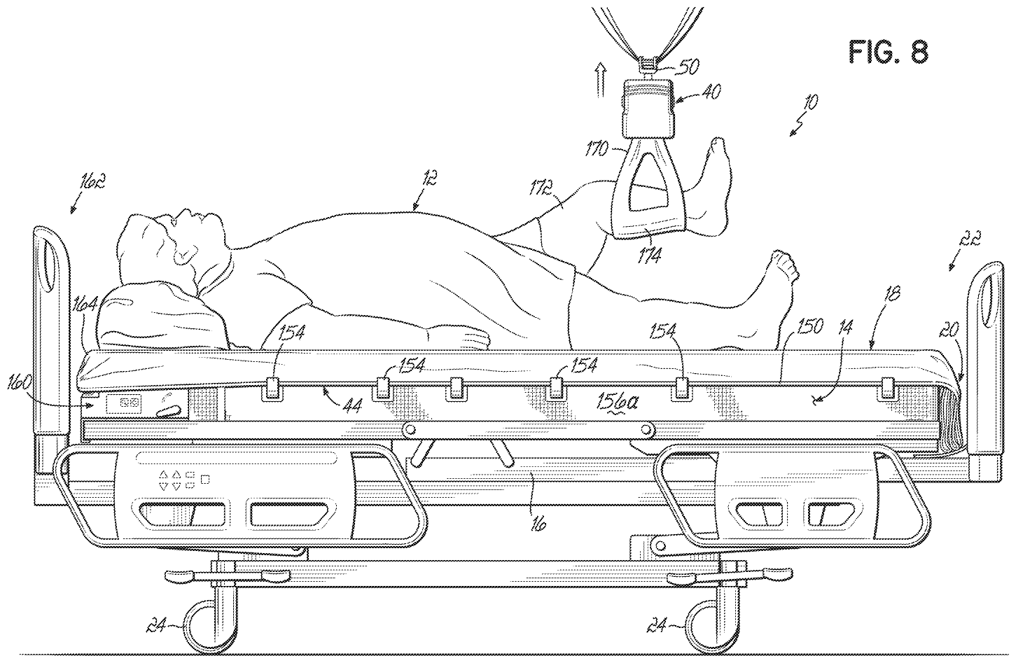

Instead of repositioning the entire patient 12, the clamp 40 and a lifting structure 170 may be used to position or move one body part or limb 172, such as a leg or arm, of the patient 12 lying on a support surface, such as a mattress 14 as depicted in FIG. 8. The lifting structure 170 may be a sling, strap, fabric swath, belt, cord, etc. To position the body part 172, the lifting structure 170 is placed underneath and around the body part 172. An end 174 of the lifting structure 170 is grasped by the clamp 40 which is connected to the pulling device 30. The pulling device 30 is then activated to pull the lifting structure upwards so as to at least partially lift the body part 172 away from the mattress 14.

The positioning method contemplates that only the sheet 18 underlying the patient 12 is required to be present to position or rotate the patient. In other words, with a sufficiently strong sheet, no sling or strap or other slide sheet is needed to position or rotate the patient 12 using the clamp 40 and the pulling device 30 above the mattress. This is very beneficial because it is well known in the healthcare industry that fewer layers of fabric or material between the mattress and the patient 12 enables the mattress 14 to provide a better skin care environment for the patient 12 (e.g., better pressure, temperature, and moisture control).

The invention further contemplates an arrangement whereby the clamp 40 hangs from a fixed height and the bed is lowered to create the same lifting action on the sheet. This arrangement may be employed in an at home environment where the pulling device 30 is not available but a stationary overhead weight-bearing strap is.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A method of positioning a patient lying on a sheet that resides on a mattress, the sheet having opposing longitudinal side edges that are retained by retainers located along corresponding opposing first and second longitudinal sides of the mattress, comprising:
removing a first longitudinal side edge of the sheet from the respective retainers located along the first longitudinal side of the mattress;
securing the removed first side edge of the sheet to a clamp, the clamp operatively connected to a pulling device located above the mattress; and
operating the pulling device to pull upwardly the clamp and the first longitudinal side edge of the sheet that is secured thereto, whereby upward movement of the first longitudinal side edge of the sheet causes the patient lying thereon to be positioned toward the second longitudinal side of the mattress that is opposite the first longitudinal side.

2. The method of claim 1 wherein the sheet has a tensile strength greater than a sheet that contains cotton.

3. The method of claim 1 wherein the securing the removed first side edge of the sheet to the clamp further comprises compressing opposite sides of the sheet within a pair of engagement members located within the clamp, so as to not adversely affect the structural integrity of the sheet.

4. The method of claim 1 wherein the pulling device is mounted to a ceiling above the mattress.

5. The method of claim 1 wherein the pulling device is mounted to a mobile frame.

6. The method of claim 1 wherein the clamp includes first and second handles pivotally coupled to each other and configured to move between a first position and a second position, wherein the first and second handles are biased to the first position and in the first position the pair of engagement members compress opposite sides of the sheet.

7. The method of claim 6 wherein when the first and second handles are in the second position the pair of engagement members do not compress opposite sides of the sheet.

8. The method of claim 7 wherein the clamp includes a spring to bias the first and second handles to the first position.

9. The method of claim 1 wherein the clamp includes a strap configured to operatively connect the clamp to the pulling device.

10. The method of claim 1 further comprising:
unsecuring the first longitudinal side edge of the sheet from the clamp and then placing the unsecured first side edge back within the retainers on the first longitudinal side of the mattress.

11. (canceled)

12. A method of positioning a patient supported on a sheet that is located on a mattress, the mattress having a first set of retainers located along a first side of the mattress and a second set of retainers located along a second side of the mattress, opposite the first side, the first and second set of retainers retaining respective first and second side edges of the sheet, a clamp connected to a pulling device positioned above the mattress, the method comprising:
releasing the first side edge of the sheet from the first set of retainers;
grasping the first side edge of the sheet with the clamp; and
causing the pulling device to pull the clamp and thus the sheet upwards so as to at least partially reposition the patient from an initial position toward the second side of the mattress.

13. The method of claim 12 further comprising:
causing the pulling device to lower the clamp and thus lowering the sheet;
releasing the first side edge of the sheet from the clamp; and
connecting the first side edge of the sheet to the first set of retainers.

14. The method of claim 12 wherein the sheet has a tensile strength greater than a sheet that contains cotton.

15. The method of claim 12 wherein the mattress has a first length and the sheet as a second length that is at least 50% longer that the first length.

16. The method of claim 12 wherein the first side edge of the sheet includes a corded hem and the clamp is configured to grasp the sheet at the corded hem.

17. (canceled)

18. (canceled)

19. (canceled)

20. (canceled)

21. (canceled)

22. (canceled)

23. (canceled)

24. (canceled)

25. A system for positioning a patient lying on a mattress supported on a bed, comprising:
a sheet residing on the mattress under the patient, the sheet having first and second side edges that are retained by retainers located along corresponding opposing longitudinal first and second sides of the mattress;
a pulling device located above the mattress; and
a clamp operatively connected to the pulling device and adapted to compressively engage opposite sides of the first side edge of the sheet after the first side edge has been removed from the respective retainers, to thereby secure the sheet to the clamp and enable the pulling device to be operated so as to pull in an upward direction the clamp and the sheet secured thereto, whereby the upward movement of the secured sheet causes the patient to be repositioned toward a second longitudinal side of the mattress opposite the first longitudinal side.

26. The system of claim 25 wherein one of the bed and the pulling device is movable relative to the other.

27. The system of claim 25 wherein the bed is wheel supported and the pulling device is mounted to a ceiling.

28. The system of claim 25 wherein the pulling device is mounted to a mobile frame.

29. The system of claim 25 and further comprising:
a housing located at a head end of the bed and operatively connected to a head end of the sheet and adapted to pull the sheet longitudinally along the mattress while the first and second side edges thereof are retained by the retainers of the longitudinal sides of the mattress, the sheet having a length that is greater than the length of the mattress.

30. (canceled)

31. (canceled)

32. (canceled)

33. (canceled)
